(19) United States
(12) Patent Application Publication
(10) Pub. No.: US 2015/0021269 A1
(43) Pub. Date: Jan. 22, 2015

(54) CONTROLLING MICROBIAL ACTIVITY AND GROWTH IN A MIXED PHASE SYSTEM

(71) Applicants: Dennis R. Enning, Calgary (CA); Jennifer A. Hornemann, Englewood, CO (US)

(72) Inventors: Dennis R. Enning, Calgary (CA); Jennifer A. Hornemann, Englewood, CO (US)

(21) Appl. No.: 14/312,097

(22) Filed: Jun. 23, 2014

Related U.S. Application Data
(60) Provisional application No. 61/857,061, filed on Jul. 22, 2013.

(51) Int. Cl. C02F 1/28; B04C 9/00; C09K 8/52; B01D 15/10; E21B 43/34; E21B 43/16

(52) U.S. Cl. CPC C02F 1/281; E21B 43/34; E21B 43/16; C09K 8/52; B01D 15/10; B04C 9/00; C02F 2101/105
USPC 210/663; 166/267; 166/67; 210/198.1; 210/85

(57) ABSTRACT

A system and methods for controlling microbial activity and growth in a mixed phase system. The method includes providing a rare-earth compound. The method also includes injecting the rare-earth compound into a mixed phase system, wherein the rare earth compound binds with a phosphate in an aqueous phase to adsorb the phosphate. The method also includes separating the rare-earth compound from the mixed phase system.

### CROSS REFERENCE TO RELATED APPLICATIONS

This application claims the priority benefit of U.S. patent application Ser. No. 61/857,061 filed Jul. 22, 2013 entitled CONTROLLING MICROBIAL ACTIVITY AND GROWTH IN A MIXED PHASE SYSTEM, the entirety of which is incorporated by reference herein.

### FIELD OF THE INVENTION

The present techniques relate generally to injecting a suspension of a rare earth oxide compound into a mixed phase system containing a phosphate concentration. More specifically, the present techniques provide for the use of the rare-earth oxide compound to render the phosphate permanently unavailable for biological uptake in order to control microbial activity and growth, thereby mitigating undesired microbial processes such as microbiologically influenced corrosion (MIC) and reservoir souring.

### BACKGROUND

This section is intended to introduce various aspects of the art, which may be associated with exemplary embodiments of the present techniques. This description is believed to assist in providing a framework to facilitate a better understanding of particular aspects of the present techniques. Accordingly, it should be understood that this section should be read in this light, and not necessarily as admissions of prior art.

The production of hydrocarbons from a reservoir well oftentimes carries with it the incidental production of non-hydrocarbon gases. In certain instances, such gases may include hydrogen sulfide (H₂S). The H₂S may be naturally present or may be the result of microbial activity, for example, triggered by the injection of water for secondary oil recovery. The latter process is referred to as reservoir souring. Depending on the level of reservoir souring (i.e. the amount of H₂S in the reservoir), significant corrosion problems and significant increased costs in material used for production equipment can be incurred. Additional costs are also incurred in safety system requirements to handle the presence of the H₂S. Estimates of additional material costs to accommodate reservoir souring for a single carbon steel offshore production facility can total $500,000,000 USD, with the incremental costs split about evenly between subsurface and surface materials.

The primary mechanism for reservoir souring is the microbial conversion of sulfate, sulfite, sulfur, and thiosulfate to H₂S caused by a specialized group of microorganisms. Specifically, this includes a biological reaction in microorganisms, such as sulfate reducing (or sulfur reducing) bacteria (SRB) or sulfate-reducing archaea (SRA). As used herein, the term SRB includes SRB, SRA, or both. SRB may be used to reduce partially oxidized sulfur compounds (such as sulfate) to H₂S in a reaction coupled to the oxidation of oil organics such as volatile fatty acids (VFA), whereby the presence of micronutrients such as phosphate (PO₄³⁻) may be a prerequisite for microbial activity and growth. Consequently, given that phosphate is an essential molecule for biological processes, if no phosphate is available, there is no microbial growth to facilitate the H₂S formation.

Various methods have been developed in recent years to mitigate biogenic souring (i.e. microbial activity). For instance, the treatment of injected water with some biocides can be effective at killing planktonic microorganism. Sulfate removal can also be effective at mimimzing reservoir souring. However, sulfate removal units are costly and add significantly to the weight of offshore installations. Phosphate removal via membrane filtration has also been proposed to limit the phosphate being injected with seawater. Perchlorate has been proposed as an effective material to suppress SRB and/or SRA and aid in the removal of H₂S by biological oxidation. Additionally, the injection of nitrate has been used as another mitigation strategy. The injection of nitrate stimulates the growth of nitrate reducing bacteria to outcompete SRB and/or SRA for limiting nutrients, therefore, leading to the eventual inhibition of H₂S production in an aqueous environment.

Another source of significant corrosion problems caused by microorganisms includes microbial corrosion. Microbial corrosion in mixed phase systems, such as hydrocarbon pipelines, results from the direct colonization of ferrous structures with various environmental microorganisms including, but not limited to SRB. The microorganisms corrode the ferrous and other metal structures through direct metal—microbe interaction, as well as in other complex ways, e.g., through excretion of polymeric organic substances. Microbial corrosion is a serious problem in the oil and gas industry and occurs in soured and non-soured environments alike. Although microbial corrosion is different from the corrosive effects of biogenic H₂S, the responsible microbial corrosive biofilms also require the phosphate nutrient in addition to other nutrients in order to facilitate a corrosive effect.

As previously suggested with reservoir souring, phosphate removal represents a novel concept to mitigate microbial corrosion. Additionally, the mitigation of microbial corrosion in oil and gas production is commonly attempted with routine biocide treatments and/or regular pigging operations of pipelines.

U.S. Patent Application Publication No. 2009/0107919 by Burba, III et al.

describes treating an aqueous solution containing a chemical contaminant with an aggregate composition containing an insoluble rare-earth compound. The contact between the aqueous solution and the aggregate composition removes and/or de-toxifies the chemical contaminant to yield an aqueous solution depleted of chemical contaminants.

U.S. Patent Application Publication No. 2010/0243571 by Semiat et al. describes passing an aqueous fluid polluted with phosphate contaminates through an adsorbent material to yield an aqueous fluid purified from the phosphate. Further, the aqueous fluid polluted with phosphate contaminates can be treated with an adsorbent material to yield a purified adsorbent material, a purified phosphate solution, and purified water.

Gerber C. Lukas, Phosphate starvation as an antimicrobial strategy: the controllable toxicity of lanthanum oxide nanoparticles, 48 CHEM. COMMUN. 3869-3871 (2012), describes using lanthanum oxide nanoparticles as an antimicrobial strategy for the removal of phosphate. Gerber investigates the ability of lanthanum oxide nanoparticles to sterilize a compartment by actively removing phosphate from the microbial growth medium, eventually resulting in the death of microorganisms. The microorganisms studied by Gerber included bacteria, fungi, and algae species including Escherichia coli, Staphylococcus carnosus, Penicillium roqueforti and Chlorella vulgaris.

All of the techniques described above provide for lower phosphate levels in aqueous solutions. However, a need clearly remains for a method of removing phosphate concentration from a mixed phase system consisting of both an organic phase material and inorganic phase material.

### SUMMARY

An exemplary embodiment provides a method for controlling microbial activity and growth in a mixed phase system. The method includes providing a rare-earth compound and injecting the rare-earth compound into a mixed phase system, wherein the rare earth compound binds with a phosphate in an aqueous phase to adsorb the phosphate. The rare-earth compound may be separated from the mixed phase system.

The mixed phase system may include an organic phase and an inorganic phase. Further, the rare-earth compound may be mixed with an aqueous solution to form a suspension before injection into the mixed phase system. The suspension may be mixed in a mixing tank before injection into the mixed phase system. A feeding system may be used for the injection of the suspension. Further, a pump may be used to blend the suspension with the mixed phase system.

The suspension in the mixing tank may be flowed through an injection line and into a tubular construct containing the mixed phase material. The rare-earth compound may be bound directly to the phosphate in the aqueous phase. The aqueous phase may then substantially remove of phosphate. The organic phase and the inorganic may be passed into a cyclone separator to produce an overflow that may substantially include of the organic phase and an underflow that may substantially include of the inorganic phase. The rare-earth compound in the suspension may be recycled for reuse after passing the suspension into the cyclone separator.

Another exemplary embodiment provides a method for controlling microbial activity and growth during hydrocarbon production. The method includes completing a well in a formation to access a reservoir, wherein the reservoir includes a mixed phase material including a phosphate in an aqueous phase. A rare-earth compound may be injected into the well, wherein the rare-earth compound flows into the mixed phase material and binds with the phosphate in the aqueous phase. The method includes removing the mixed phase material from the well, separating a hydrocarbon-containing material from the mixed phase material, and separating the rare-earth compound from the hydrocarbon-containing material.

The rare-earth compound may be in particle form with a porous structure and includes lanthanum oxide particles. Further, the concentration of the lanthanum oxide particles may be in the range of about 1 ppm to about 1000 ppm. The applied concentration of lanthanum oxide nanoparticles may take into account the load of phosphate in the system to be treated. Phosphate concentrations in natural and engineered aqueous environments can vary. Consequently, in some embodiments of the invention lanthanum oxide nanoparticles may be used at a concentration of below about 5 ppm. In other cases, a range of about 20 to about 200 ppm or about 50 ppm to about 200 ppm may be applied. There may be embodiments of the invention for which a dosage of more than about 200 and less than about 1000 ppm or more than about 500 ppm and less than about 1000 ppm of lanthanum oxide nanoparticles is desirable for effective microbial control. The rare-earth compound may include cerium oxide, yttrium oxide, or gadolinium oxide. Any compound that can adsorb phosphate may be injected into the reservoir.

Another exemplary embodiment provides a system for inhibiting bacteria growth. The system may include a mixed phase system with phosphate in an aqueous phase and a rare-earth compound in an aqueous mixture to form a rare-earth suspension. The system may include an injection system to inject the rare-earth suspension into the mixed phase system to adsorb the phosphate in the aqueous phase and a separation system to separate the rare-earth suspension from the mixed phase system.

The mixed phase system may include an organic phase and an inorganic phase wherein the organic phase includes hydrocarbons including oil or gas or both. The inorganic phase includes an aqueous solution. Furthermore, the mixed phase system may be contained within a tubular construct and include a phosphate concentration ranging from about 0.01 ppm to about 10 ppm or about 0.01 ppm to about 1 ppm. The rare-earth compound may include a lanthanum oxide (La₂O₃) concentration ranging from about 1 ppm to about 1000 pm or about 50 ppm to about 200 ppm. In some embodiments of the invention lanthanum oxide nanoparticles may be used at a concentration of below about 5 ppm. In other cases a range of about 20 to about 200 ppm may be applied. There may be embodiments of the invention for which a dosage of more than about 200 or more than about 500 ppm of lanthanum oxide nanoparticles is desirable for effective microbial control. Further, the rare-earth suspension may be mixed in a mixing tank prior to injection into the mixed phase system and pumped from the mixing tank through an injection line and into the mixed phase system. The rare-earth suspension may be injected into a flow stream of the mixed phase system in a reservoir extraction process or a hydraulic fracturing process. The mixed phase system may be substantially free of phosphate after adsorption and a residual amount of phosphate may be in the range of about 0.0001 ppm to about 0.01 ppm or about 0.0001 ppm to about 0.0005 ppm after adsorption. In certain embodiments of the invention, a phosphate concentration larger than about 0.01 ppm may result from rare earth mineral treatment. In some cases, this may control microbial activity and growth. A measurement system to measure the concentration of phosphate remaining after adsorption may be used.

### BRIEF DESCRIPTION OF THE DRAWINGS

The advantages of the present techniques are better understood by referring to the following detailed description and the attached drawings, in which:

FIG. 1 is a drawing of a process to produce hydrocarbons from a reservoir utilizing waterflood or seawater injection system;

FIG. 2 is a drawing of a hydraulic fracturing process to produce hydrocarbons from an onshore reservoir;

FIG. 3 is an enlarged drawing of a fissure formed during a hydraulic fracturing process to produce hydrocarbons from a reservoir;

FIG. 4A is a drawing of a tubular construct detailing the flow of a mixed phase system including the injection of a rare-earth oxide compound slurry therein;

FIG. 4B is a drawing of a suspension consisting of an aqueous solution and rare-earth oxide particles;

FIG. 5 is a drawing of the necessary chemical compound phosphate needed for microbial activities during H₂S generation;

FIGS. 6A and 6B are schematic views of La₂O₃ particles before and after exposure to a phosphate concentration;

FIG. 7 is a theoretical plot of a La₂O₃ particles concentration plotted against a phosphate concentration;

FIG. 8A is a plot showing a theoretical graph of the influence of La₂O₃ particles on microbial H₂S generation;

FIG. 8B is a plot showing a theoretical graph of the influence of La₂O₃ particles on microbial corrosion rates;

FIG. 9 is a drawing of a cyclone separator to separate the organic phase material and the inorganic phase material of the mixed phase system; and

FIG. 10 is a process flow diagram of a method for injecting a rare-earth oxide compound into a mixed phase system for adsorption of phosphate.

### DETAILED DESCRIPTION

In the following detailed description section, specific embodiments of the present techniques are described. However, to the extent that the following description is specific to a particular embodiment or a particular use of the present techniques, this is intended to be for exemplary purposes only and simply provides a description of the exemplary embodiments. Accordingly, the techniques are not limited to the specific embodiments described below, but rather, include all alternatives, modifications, and equivalents falling within the true spirit and scope of the appended claims.

At the outset, for ease of reference, certain terms used in this application and their meanings as used in this context are set forth. To the extent a term used herein is not defined below, it should be given the broadest definition persons in the pertinent art have given that term as reflected in at least one printed publication or issued patent. Further, the present techniques are not limited by the usage of the terms shown below, as all equivalents, synonyms, new developments, and terms or techniques that serve the same or a similar purpose are considered to be within the scope of the present claims.

“Adsorption” refers to a process by which a gas, liquid, or dissolved material is assimilated onto the surface of a solid or liquid material and defined in terms of adsorptive surface area per unit mass. The adsorption may be based on physical effects, called physisorption, or on chemical interactions, termed chemisorption.

An “aqueous phase” refers to a fluid stage of a substance that is based on water in a liquid state, such as a solution of a substance in water.

“Biogenic hydrogen sulfide” refers to the principal noxious gas that can be released during hydrocarbon production operations and is the metabolic end product of microbial sulfate respiration. The generation of biogenic hydrogen sulfide results in a variety of oil recovery problems, including oil reservoir souring, contamination of crude oil and metal corrosion.

“Fracturing” refers to the process and methods of breaking down a geological formation and creating a fracture, i.e. the rock formation around a well bore, by pumping fluid at very high pressures, in order to increase production rates from a hydrocarbon reservoir. The fracturing methods otherwise use conventional techniques known in the art.

“Hydraulic Fracturing” refers to creating or opening fractures that extend from the wellbore into formations. A fracturing fluid, typically viscous, can be injected into the formation with sufficient hydraulic pressure (for example, at a pressure greater than the lithostatic pressure of the formation) to create and extend fractures, open pre-existing natural fractures, or cause slippage of faults. In the formations discussed herein, natural fractures and faults can be opened by the pressure. A proppant may be used to “prop” or hold open the fractures after the hydraulic pressure has been released. The fractures may be useful for allowing fluid flow, for example, through a tight shale formation, or a geothermal energy source, such as a hot dry rock layer, among others.

The fracturing fluid is typically 90% water, 9.5 proppant, and about 0.5% chemical additives. The water used in the fracturing fluid may contain nutrients such as phosphate and sulfate. Such nutrients may hasten the present risk of microbial activity or create a new risk for reservoir souring, corrosion, or both.

“Hydrocarbons” refer to an organic compound that primarily includes the elements hydrogen and carbon, although nitrogen, sulfur, oxygen, metals, or any number of other elements may be present in small amounts. As used herein, hydrocarbons generally refer to components found in natural gas, oil, or chemical processing facilities.

“Injection Fluid” refers to the injection of stimulant fluids into a subterranean reservoir to increase the pressure within the reservoir, increase the temperature within the reservoir, decrease the viscosity of liquid hydrocarbon deposits contained within the reservoir, and/or increase the production of hydrocarbons in any suitable manner and/or via any suitable mechanism. Illustrative, non-exclusive examples of fluid injection include any of the secondary hydrocarbon recovery techniques disclosed herein, such as waterflooding, in which water is supplied to a subterranean reservoir via an injection well. This water may increase the pressure within the reservoir and may sweep hydrocarbons contained within the reservoir from the injection well to a production well, where it may be removed (i.e., produced) from the reservoir.

“Inorganic” refers to a composition of matter not arising from natural growth.

“Organic” refers to a composition of matter composing organic compounds originating from the remains of once-living organisms such as plants and animals and their waste products.

“Overburden” refers to the subsurface formation overlying the formation containing one or more hydrocarbon-bearing zones (the reservoirs). For example, overburden may include rock, shale, mudstone, or wet/tight carbonate (such as an impermeable carbonate without hydrocarbons). An overburden may include a hydrocarbon-containing layer that is relatively impermeable. In some cases, the overburden may be permeable.

As used herein, “phosphate” refers to any number of anions related to the structure: PO₄³⁻. In aqueous solutions, any number of counter-ions, such as lithium, sodium, and potassium, among others, may be present. The form the phosphate takes depends on the pH of the solution. In a strongly basic solution, e.g., above a pH of about 12.67, the phosphate is present mainly as the phosphate ion (PO₄³⁻). In weakly basic conditions, e.g., around a pH of about 7.21, the phosphate is present mainly as the hydrogen phosphate ion (HPO₄²⁻). In strongly acidic conditions, e.g., at a pH of about 2.12, the phosphate is present mainly as the dihydrogen phosphate ion (H₂PO₄⁻). In very strongly acidic conditions, e.g., less than a pH of about 1, the main form is trihydrogen phosphate (H₃PO₄). As used herein, the term phosphates encompasses all of these forms.

“Proppants” refers to a composition of sized particles mixed with fracturing fluid to open and/or hold fractures open during and after a hydraulic fracturing treatment. In addition to naturally occurring sand grains, the sized proppant particles can be man-made or specially engineered particles, such as resin-coated sand or high-strength ceramic materials like sintered bauxite.

“Rare earth elements” (also referred to as rare earth metals) refers to a set of seventeen chemical elements in the periodic table, including Lanthanum (La). The rare earth compounds include a rare earth element and at least one other element selected from chalcogens, halogens, and phosphorus. Examples of rare earth compounds include lanthanum oxide, cerium oxide, yttrium oxide, or gadolinium oxide.

A “reservoir” refers to a subsurface rock formation from which a production fluid can be harvested. The rock formation may include granite, silica, carbonates, clays, and organic matter, such as oil, gas, or coal, among others.

“Reservoir souring” refers to the production of increased concentrations of H₂S in well-stream fluids from production wells subject to water injection for secondary recovery as a consequence of microbial reduction of sulfate and other partly oxidized sulfur compounds.

“Substantial” when used in reference to a quantity or amount of a material, or a specific characteristic thereof, refers to an amount that is sufficient to provide an effect that the material or characteristic was intended to provide. The exact degree of deviation allowable may depend, in some cases, on the specific context.

A “suspension” refers to a heterogeneous mixture containing solid particles. The internal phase (solid) is dispersed throughout the external phase (fluid) with the use of certain excipients or suspending agents. Suspensions will eventually settle over time if left undisturbed.

“Subterranean formation” refers to the material existing below the Earth's surface. The formation may comprise a range of components, e.g. minerals such as quartz, siliceous materials such as sand and clays, as well as the oil and/or gas that is extracted.

“Thixotropy” refers to a property exhibited by certain semi-solid compounds that become a fluid when stirred or shaken and return to an original semi-solid state upon standing.

“Tubular construct” refers to tubing or a system of tubes, tubulars, pipes, pipelines, flowlines, and the like used for holding or transporting any liquids and/or gases, and any incidental particulate matter or solids, from one location to another.

“Volatile fatty acids” (VFAs) refers to fatty acids with a carbon chain of six carbons or fewer. VFAs are present in many hydrocarbon produced waters, and they may be a predominant factor in the activity of sulfate-reducers in hydrocarbon reservoirs, the sour gas formation during water-flooding for enhanced recovery, and contaminants in hydraulic fracturing fluids.

“Water-cut” refers to the ratio of water produced compared to the volume of total liquids produced.

“Wellbore” refers to at least one wellbore drilled into a subterranean formation, which may be a reservoir or adjacent to a reservoir. A wellbore can have vertical and horizontal portions, and it can be straight, curved, or branched. As used herein, the term “wellbore” refers to a wellbore itself, including any uncased, open-hole portion of the wellbore.

### Overview

The present techniques provide for the use of a rare-earth oxide compound for the adsorption of phosphates. More specifically, in various embodiments, the phosphates are contaminants in a mixed phase system comprising both an organic phase material and an inorganic phase material. A suspension of the rare-earth oxide compound can be directly injected into a flowing stream of the mixed phase system where the rare-earth oxide compound binds directly to the phosphates within the mixed phase system. The adsorption process may take place in flowing facilities equipment, such as a pipeline or a wellbore, or downhole of the hydrocarbon reservoir. Additionally, the rare-earth oxide compound can be pre-mixed with an aqueous solution to form a suspension and held in a storage tank prior to injection.

The use of the rare-earth oxide compound reduces the concentration of phosphate ions, which is a necessary nutrient required for microbial activity and growth. Microbial activity leads to undesired processes such as reservoir souring and microbial corrosion. Microorganisms associated with reservoir souring produce toxic and corrosive H₂S. Conversely, the active microorganisms associated with microbial corrosion facilitate the direct or indirect destruction of metallic structures such as hydrocarbon pipelines. As the phosphate concentration decreases, it becomes the limiting nutrient for microbial conversion of sulfur-based compounds, such as sulfate, sulfite, and thiosulfate, among others, to H₂S. Further, the removal of phosphate may inhibit or prevent microorganism activity that directly leads to the corrosion of metallic structures. Therefore, the main objective for the injection of the rare-earth oxide compound into a mixed phase system includes the reduction or elimination of the phosphate concentration within the system to control microbial activity, thereby eliminating reservoir souring and microbiologically influenced corrosion.

### Method for Controlling Microbial Growth and Inhibiting Microbial Corrosion

Reservoir souring may occur as the result of inherent microbial activity in the reservoir facilitated by a change in the reservoir conditions, for example, by the injection of any source water containing phosphates and other nutrients, by lowering the temperature, increasing the pH, or changing any number of other environment variables that create a better environment for microbial activity. Microbial corrosion may occur as a result of bacterial microbes in combination with other environmental conditions including metallic structures, nutrients, water, and oxygen. The generation of H₂S by microbial activity occurs primarily in the water phase during reservoir souring. The level of H₂S in the reservoir water phase can range from a few milligrams per liters (mg/l) to just above 100 mg/l. Furthermore, the level of souring is dependent on the temperature and typical reservoir souring levels will rise to about 50 mg/l in produced seawater. When this level of H₂S is combined with high water-cut and flashed with produced hydrocarbons, much higher levels of H₂S can be reached in the associated gas streams.

The conversion of sulfate or sulfite to H₂S by sulfate-reducing microorganisms is a mechanism that can lead to both reservoir souring and microbial corrosion. An example reaction for this process is when sulfate-reducing bacteria (SRB) or sulfate-reducing archaea (SRA) consume volatile fatty acids (VFA), e.g., the acetic acid (CH₃COOH), in the presence of all necessary nutrients, including phosphate, as shown below conceptually in Equation (1).

SRB+Sulfate+CH₃COOH+[P nutrient]→H₂S+CO2+bacterial growth (1)

SRB, which are commonly found throughout hydrocarbon production systems including the reservoir rock and production equipment, account for the majority of microbial activity and growth problems in hydrocarbon production. In general, SRB are a composition of specialized bacteria that thrive in the absence of oxygen and obtain energy for growth via the oxidation of a nutrient, e.g., VFAs, coupled to the reduction of an oxidized sulfur compound. The phosphate nutrient is acquired from the environment and is a necessary reactant that fuels microbial growth and maintenance, and hence ultimately the generation of H₂S. Therefore, a decrease in the phosphate concentration correlates to a decrease in microbial activity, and, thus, H₂S generation. The concentration of phosphate varies depending on the particular environment. In the northern part of the U.S., the phosphate concentration has been found in the range of less than 90 ppm to about 640 ppm. The phosphate concentration in more isolated waters in the northern part of the U.S. range from less than 15 ppb to about 90 ppb. In a wider sample of several bodies of waters across the U.S, the average phosphate concentration is about 10 ppb.

The generated H₂S is toxic and can cause corrosion of the equipment used in hydrocarbon processing. Depending on the level of reservoir souring and the amount of H₂S in the reservoir, significant corrosion problems and significantly increased costs in materials used in production equipment can be incurred. In fact, the presence of H₂S decreases the quality and thus the value of the hydrocarbons to be sold to market. Furthermore, generated H₂S increases operational costs due to required safety precautions, where high levels of H₂S may possible result in the shut-in of a well due to incompatibility with existing materials.

Microbial induced corrosion results from the direct attack of biofilm-forming microorganisms that grow directly on affected metallic structures. These microorganisms electrically interact with a metallic structure thereby accelerating its dissolution. While SRB play a role in this corrosive process, there are also other microorganisms, such as methanogenic archaea, that can also lead to metallic degradation. Since phosphate is a universal nutrient for all microorganisms, its effective removal inhibits or prevents activity and growth of the microorganisms thereby ultimately leading to their death. The present techniques provide an innovative approach for the removal of phosphate contaminants from a mixed phase system to eliminate microbial corrosion and reservoir souring.

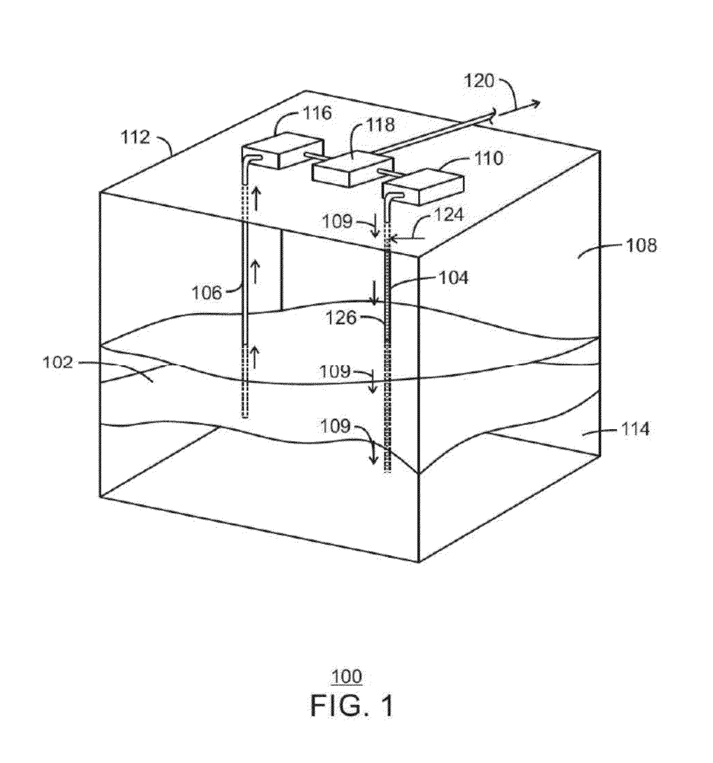

FIG. 1 is a drawing showing a process to produce hydrocarbons from a reservoir system 100. The techniques described herein are not limited to the reservoir process but may be used with any number of other processes. In the diagram 100, a reservoir 102 is accessed by an injection well 104 and a production well 106 drilled through an overburden 108 above the reservoir 102.

Referring to FIG. 1, an injection fluid 109 can be injected through the injection well 104, for example, from a pumping station 110 at the surface 112. The injection fluid 109 may be an aqueous liquid containing various chemicals, gases and the like, which can assist in displacing oil and gas production from the reservoir 102 directly, or indirectly by providing additional pressure. Once injected into the injection well 104, the injection fluid 109 flows into the reservoir 102, for example, into an aquifer 114. The reservoir 102 contains a hydrocarbon containing material which can form a flowing stream of a mixed phase material brought to the surface in the production well 106. The mixed phase material is composed of an organic phase and an inorganic phase, which is directed to a pumping station 116. The reservoir 102 and the aquifer 114 may contain phosphates which are a limiting nutrient for microbial activity and growth. As previously discussed, the phosphates, which can be found in many biogenic materials, aqueous systems, and mineral deposits, are a primary nutrient for microbial activity and growth. The continued presence of the phosphate nutrient leads to the associated problems of reservoir souring and microbial corrosion.

A rare-earth oxide compound 124 can be injected into the injection fluid 109 and into the injection well 104. The rare-earth oxide compound 124 binds to phosphate ions within the hydrocarbon containing material of the reservoir 102. The phosphates are readily adsorbed by the particles of the rare-earth oxide compound 124, which can substantially reduce the phosphate concentration and consequently reduce biogenic H₂S. Thereafter, the hydrocarbon containing materials can be produced and swept from the injection well 104 towards the production well 106. The resulting hydrocarbons may have a substantially reduced concentration of biogenic H₂S.

The drawing of FIG. 1 is not intended to indicate that the process 100 to produce hydrocarbons from a reservoir is to include all of the components shown in FIG. 1. Further, any number of additional components may be included within the process 100, depending on the details of the specific implementation. For example, the process 100 may include any suitable types of condensers, pumps, compressors, other types of separation and/or fractionation equipment, and pressure-measuring devices, temperature-measuring devices, or flow-measuring devices, among others.

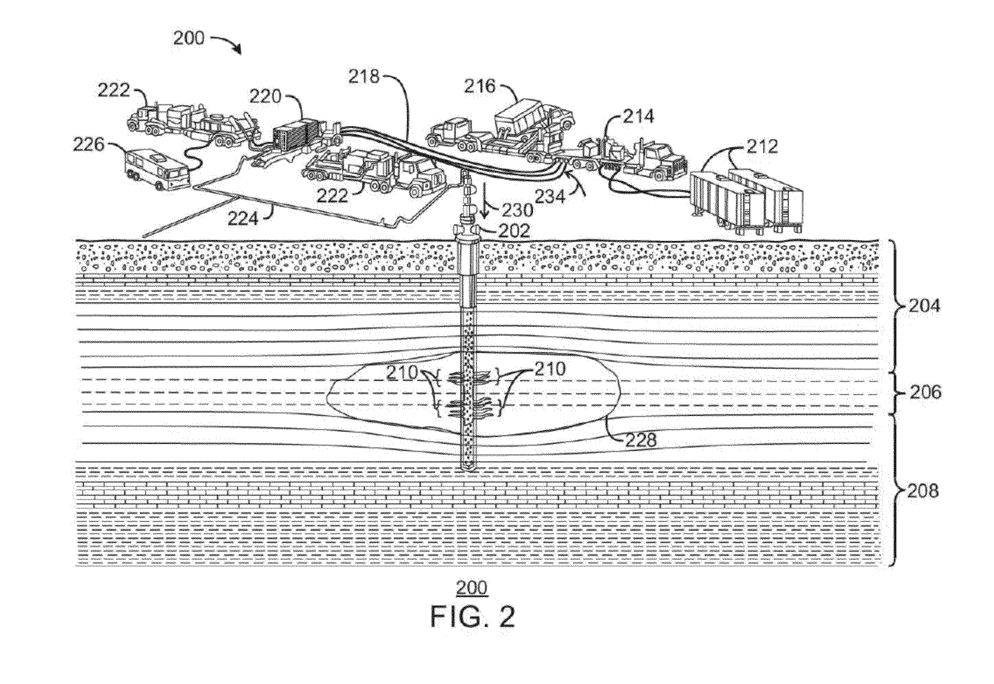

FIG. 2 depicts a hydraulic fracturing process 200 to produce oil and natural gas from a reservoir. In typical hydrocarbon operations, the technology involves pumping a water-sand mixture (often referred to as “mud”) into subterranean layers where the oil or gas is trapped. The pressure of the water-sand mixture creates tiny fissures or fractures in the rock. After completion of the pumping, the sand will prop open the fractures, allowing the oil or gas to escape from the hydrocarbon bearing formation and flow to a well.

For example, a well 202 may be drilled through an overburden 204 to a hydrocarbon bearing subterranean formation 206. Although the well 202 may penetrate through the hydrocarbon bearing subterranean formation 206 and into the underburden 208, perforations 210 in the well 202 can direct fluids to and from the hydrocarbon bearing subterranean formation 206.

The hydraulic fracturing process 200 may utilize an extensive amount of equipment at the well site. This equipment may include fluid storage tanks 212 including a tank to hold a fracturing fluid, and blenders 214 to blend the fracturing fluid with other fluids and materials, such as high permeability proppants 216, and other chemical additives, to form a low pressure slurry 218. The low pressure slurry 218 may be run through a treater manifold 220, which may use pumps 222 to adjust flow rates, pressures, and the like, creating a high pressure slurry 224, which can be pumped down the well 202 to fracture the rocks in the hydrocarbon bearing subterranean formation 206. Additionally, an organic material or diesel oil or the like may be added to the high pressure slurry 224 for enhancement. Further, a mobile command center 226 may be used to control the fracturing process.

The goal of hydraulic fracture stimulation is to create a highly-conductive fracture zone 228 by engineering subsurface stress conditions to induce pressure parting of the formation in the hydrocarbon bearing subterranean formation 206. This is generally performed by the injection of the high pressure slurry 224 including the proppants 216, into the hydrocarbon bearing subterranean formation 206 to overcome “in-situ” stresses and hydraulically-fracture the reservoir rock. An injection fluid 230 can be injected as part of with the high pressure slurry 224 through the well 202 via the pumps 222. The injection fluid 230 may be an aqueous liquid consisting primarily of water along with various chemicals, gases and the like. A rare-earth oxide compound 234 can also be injected into the low pressure slurry 218 for injection into the well 202, as part of the high pressure slurry 224. The rare-earth oxide compound 234 readily binds to phosphates in an adsorption process to substantially reduce or eliminate the phosphate concentration from the well fluids and consequently reduce biogenic H₂S. In some embodiments, the phosphate ion concentration in the well fluids is about 0.1 ppm to about 1 ppm. A measurement system to measure the amount of phosphate concentration before and after adsorption may be included in the hydrocarbon production process. In some embodiments, the measurement system may consist of analyzers, chemical testing methods, ion probes, or the like.

The drawing of FIG. 2 is not intended to indicate that the hydraulic fracturing process 200 is to include all of the components shown in FIG. 2. Further, any number of additional components may be included within the hydraulic fracturing process 200, depending on the details of the specific implementation. For example, the hydraulic fracturing process 200 may include any suitable types of condensers, pumps, bypass lines, other types of separation and/or fractionation equipment, and pressure-measuring devices, temperature-measuring devices, or flow-measuring devices, among others.

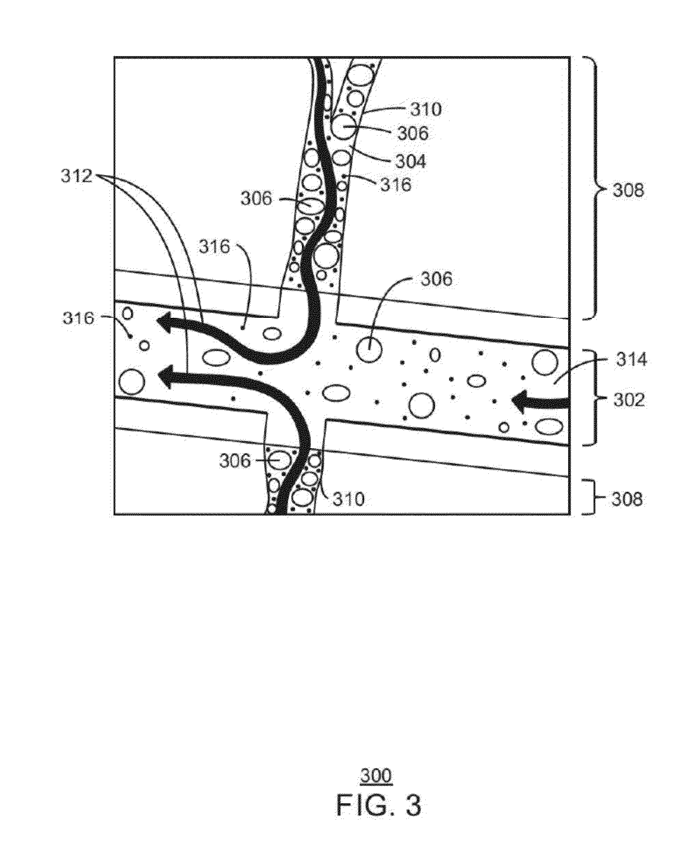

FIG. 3 is an enlarged view 300 of a portion of the perforations 210 in the well 202 of FIG. 2. Referring to FIG. 3, a high pressure slurry 304 can be injected into a well 302. The high pressure slurry 304 of FIG. 3 can include proppants 306, chemical additives, or a combination of both, which are injected under high pressure through the well 302 and eventually flow into the subterranean formation 308. The high pressure slurry 304 can be injected at a sufficient rate to increase pressure to exceed that of the pressure gradient of the subterranean formation 308. With sufficient pressure, the subterranean formation 308 cracks and fissures 310 are formed within it. The fissures 310 provide a passage for oil and gas 312 to escape and move from the subterranean formation 308 into the well 302. Proppants 306 aid in the continued opening of the generated fissures 310 and in the recovery of the oil and gas flow 312. In some embodiments, the proppants can include sand, resin coated proppants, and ceramic proppants. Each proppant type has its own advantages and disadvantages, the decisive factor used to determine which proppants to use depends on geology, availability, prices, and government regulations. In some embodiments, the chemical additives can include but are not limited to sodium chloride, ethylene glycol, borate salts, sodium/potassium carbonate, isopropanol, and the like.

In FIG. 3, an injection fluid 314, consisting primarily of water, can also be injected into the well 302. The injection fluid 314 serves to support the pressure of the reservoir and to displace the oil and gas flow 312 by pushing the flow out of the fissures 310 and towards the well 302. Any source of bulk water for the injection fluid 314 may be used. During hydrocarbon production, sources of water including produced water, aquifer water, river water, or seawater can be used, where seawater is the most common and convenient source for off-shore and near-shore production facilities.

Since water is an important factor in production, the quality of the water is a critical component as impurities in the water can reduce its efficiency. Therefore, contaminants in the injection water, such as phosphates, can be removed prior to injection into the well 302. Various methods may be implemented to rid the injection fluid 314 of contaminants prior to injection. In some embodiments, the phosphate contaminants are removed using an adsorption filtration system, a separation system, or a chemical injection method, alone or in combination. Additionally, a rare-earth oxide compound 316 can be injected into the well 302 as shown in FIG. 3. The rare-earth oxide compound 316 readily binds to and adsorbs the phosphates in an aqueous phase of the oil and gas flow 312 to substantially reduce or eliminate the phosphate concentration and consequently reduce microbial activity, mainly biogenic H₂S generation.

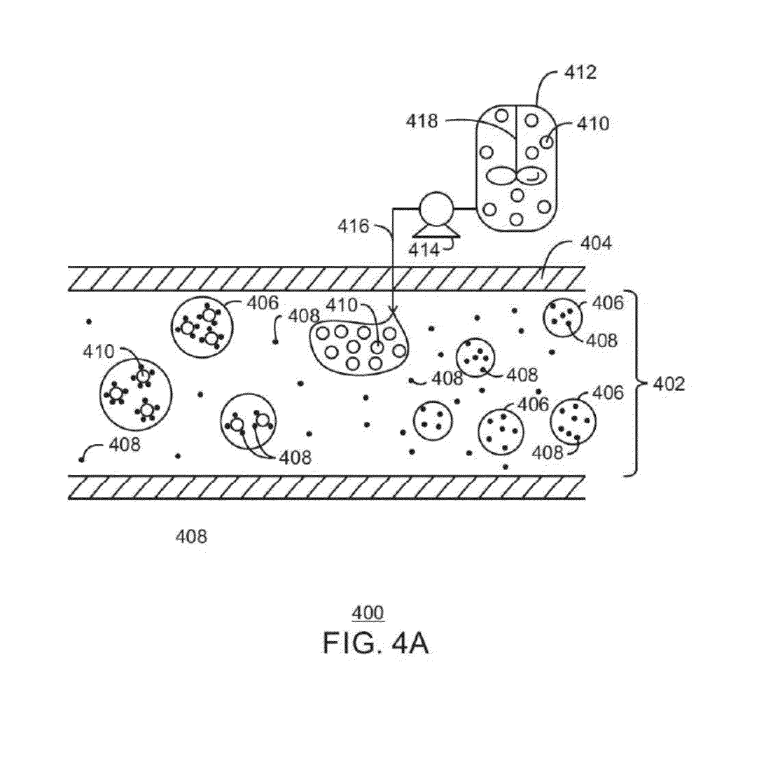

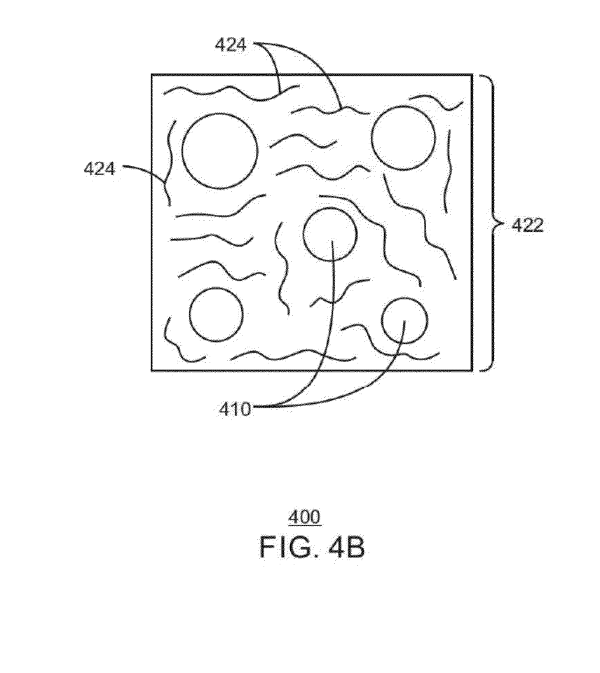

FIG. 4A is a drawing 400 detailing a flow stream of a mixed phase system 402. The system includes an organic phase, for example, flowing oil and natural gas, and an inorganic phase, for example, injection water, proppants, and other chemicals additives within a tubular construct 404, typically made from an iron alloy. The oil and gas of the organic phase entrains an aqueous phase from the reservoir that includes water droplets 406 containing phosphates 408. Particles of a rare-earth oxide compound 410 are injected into the flow stream of the mixed phase system 402. In the present technique, the rare-earth oxide compound 410 adsorbs the phosphate 408. This technique limits the phosphate concentration available for use in microbial activities and growth. Therefore, the outflow of oil and gas from the tubular construct 404 may be substantially free of phosphates.

The rare-earth oxide compound 410 can be injected into the mixed phase system 402 using a system including a mixing tank 412, a pump 414, and an injection line 416.

Within the mixing tank 412, the rare-earth oxide compound 410 may be subjected to continuous agitation using a mixing impeller 418 that is designed to move the rare-earth oxide compound 410 inside the tank 412 and provide sufficient turbulence to form and sustain a suspension. This inhibits settling of the rare-earth oxide compound 410 and facilitates even distribution of the rare-earth oxide such that a homogeneous slurry is available for injection. The pump 414 is installed downstream of the mixing tank 412 and moves the suspension that includes the rare-earth oxide compound 410 into the injection line 416. From the injection line 416, the rare-earth oxide compound 410 enters into the flowing mixed phase system 402.

The rare-earth oxide compound 410 may be in the form of micro-particles (e.g., between about 100 μm and about 800 μm in size) or nanoparticles (e.g., between about 10 nm and about 800 nm in size). As shown in FIG. 4B, particles of the rare-earth oxide compound 410 can be mixed with an aqueous solution to form a suspension 422 before injection into the mixed phase system 402. In an embodiment, the rare-earth oxide particles 410 may include lanthanum oxide (La₂O₃) particles wherein the concentration of the La₂O₃ in the final aqueous phase may be in the range of about 1 ppm to about 1000 ppm or about 50 ppm to about 200 ppm. In some embodiments of the invention lanthanum oxide nanoparticles may be used at a concentration of below about 5 ppm. In other cases a range of about 20 to about 200 ppm may be applied. There may be embodiments of the invention for which a dosage of more than about 200 and less than about 1000 ppm or more than about 500 ppm and less than about 1000 ppm of lanthanum oxide nanoparticles is desirable for effective microbial control. In other embodiments, the rare-earth particles 410 may include other rare-earth oxides particles, such as cerium oxide, yttrium oxide, gadolinium oxide, and the like, alone or in any combinations. The rare-earth oxide compound 410 is selected based on its availability in particle form, binding efficacies, and associated costs.

The particles of the rare-earth oxide 410 in the suspension 422 are scattered throughout the aqueous solution to accomplish uniformity in the particle distribution. In some embodiments, the suspension 422 may be continually mixed over a particular time frame after blending of the particles of the rare-earth oxide 410 and the aqueous solution. Mechanical mixing methods may include agitation, vibration, sonication and centrifugation techniques, among others. In some embodiments, the suspension can be mixed without mechanical agitation. Passive techniques, such as static mixers, and the like, can be used to affect the mixture.

The particles of the rare-earth oxide 410 may encompass any diameter size with there being a continuous diameter size distribution within the suspension 422. A particle diameter in a lower diameter particle range will help to prevent settling of the particles in a suspension whereas particles having a larger diameter will usually settle from the suspension at a faster rate due to the effects of gravity. In some embodiments, the rare-earth oxide particles 410 can be coated with a solvent, such as polysiloxane, to protect and maintain the particles during injection before the particles are actually exposed to the phosphate within the water droplets.

The particles of the rare-earth oxide 410 will generally be hydrophilic in nature, i.e., with a high affinity to water, since its chemical structure and associated charge favors the formation of hydrogen bonds in a polarized environment. This may help the rare earth oxides 410 to locate in the water droplets 406, providing higher activity, since both the bacteria and the phosphate ions will tend to be located in the water droplets. This attraction of the particles of the rare-earth oxide 410 to the water also lends to a strong attraction of the particles of the rare-earth oxide 410 to the phosphates. This high affinity for phosphates may effectively remove the phosphates from the water molecules and render the phosphate permanently unavailable for biological uptake. Additionally, the particles of the rare-earth oxide 410 can have a porous structure and a high surface area which facilitates substantial or total adsorption of phosphates.

In some embodiments, a thickening agent 424 could be added to increase the viscosity of the suspension 422, thereby reducing the movement and settlement of the suspended particles of the rare-earth oxide 410 and stabilizing the suspension 422 as a whole. The thickening agent can be a water soluble polymer with a relatively high viscosity. Further, a thixotropic thickening agent 424 may be used. A thixotropic thickening agent 424 remains in a semi-gelled state in the absence of shearing, but becomes thinner and flows when agitated, shaken, or otherwise stressed. The thixotropic thickening agent 424 would return to a more viscous or semi-gelled state over the passage of time when no shear is applied. Therefore, particle settling of the rare-earth oxide 410 would be hindered when the suspension 422 is in a higher viscosity state. In certain embodiments, the thickening agent 424 may be guar gum, polyethylene glycol, polyethylene oxide, and other polymers or combinations thereof

The drawing of the mixed phase system 400 is not intended to indicate that the mixed phase flow stream 402 is to include all of the components of FIG. 4A and FIG. 4B. Further, any number of additional components may be included within the mixed phase flow stream 402 depending on the details of the specific implementation.

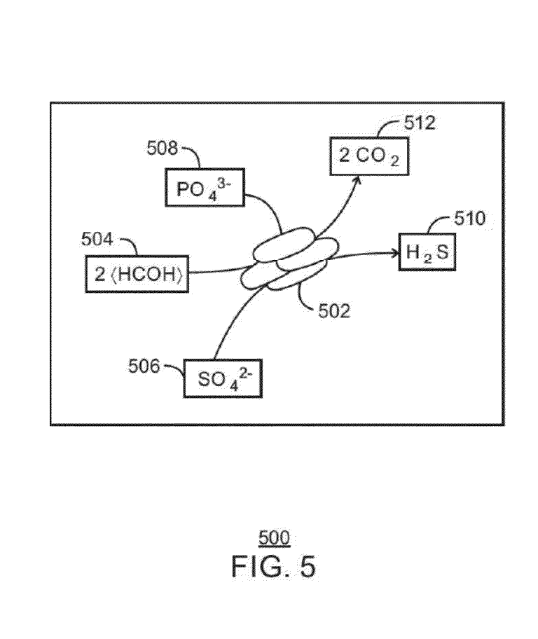

FIG. 5 depicts a reaction to form H₂S 500. The reaction begins with SRB 502 located within an aqueous phase of either a hydrocarbon or an aqueous-based fluid like seawater, hydraulic fracturing fluid, or other similar fluid. The SRB can grow in the absence of oxygen, but do require an electron donor and electron acceptor to power cellular processes. In FIG. 5, an organic electron donor 504, schematically 2(HCOH), and an electron acceptor 506, SO₄²⁻, provide the necessary components to enable the activity of the SRB 502. The SRB 502 metabolizes the electron donor 504 and transfers electrons to the electron acceptor 506, thereby generating the energy needed to maintain cellular functions and growth. Additionally, the SRB 502 generally requires the nutrient phosphate 508 for growth and maintenance. The phosphate 508 is often the limiting nutrient for microbial growth and H₂S 510 production so that any increased input of phosphate 508 to the reaction will result in increased activity and growth of the SRB 502. If any one of these components is eliminated, the SRB 502 can neither grow nor exhibit microbial activity. The electron donor 504, the electron acceptor 506, and the phosphate 508 maintain the SRB 502 and assist in the production of H₂S 510 and carbon dioxide 512. The biological production of H₂S 510 is an underlying reason for reservoir souring and contributes to the corrosion of materials. Due to the affinity of rare-earth oxide compounds to adsorb phosphate ions, the presented techniques provide a method of effectively reducing the concentration of phosphate ions by injecting a rare-earth oxide compound into a mixed phase system thereby resulting in the reduction of the limiting nutrient, which limits the growth of the SRB 502, and may result in their eventual death. Similarly, it inhibits the activity and growth of other non-SRB microorganisms implicated in direct corrosion of ferrous production equipment.

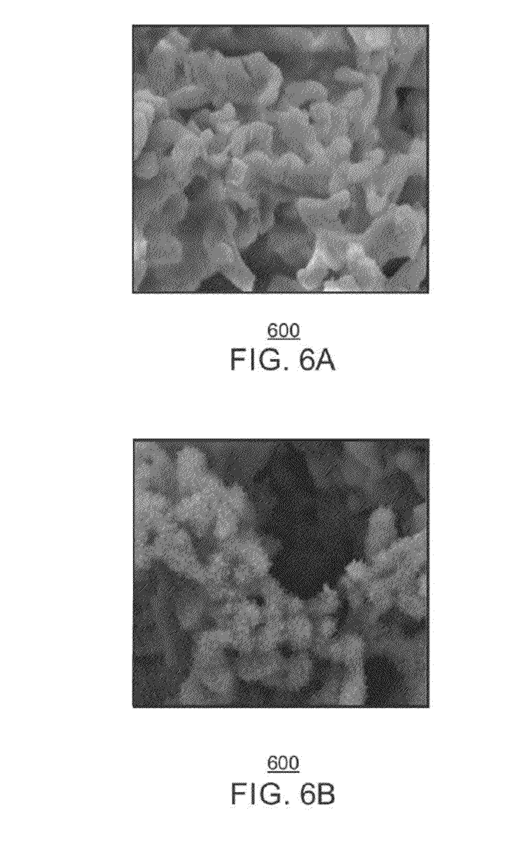

FIGS. 6A and 6B are schematic views of La₂O₃ particles before and after exposure to a phosphate concentration. Lanthanum is a rare-earth metal and is one of a set of seventeen chemical elements in the periodic table described as such. Lanthanum metal is known for its affinity to phosphate ions through adsorption.

In FIG. 6A, the La₂O₃ particles are shown before exposure to a solution containing phosphate ions. The individual La₂O₃ particles may be about 15 nanometers in size. Hence, the La₂O₃ particles provide a large surface area for phosphate adsorption.

FIG. 6B shows the La₂O₃ particles after exposure to phosphate ions. In FIG. 6B, the La₂O₃ particles bind strongly to the phosphate ions when exposed to the solution. The adsorbed phosphate ions are visible in FIG. 6B as spikes covering the La₂O₃ particles.

FIGS. 6A and 6B are not intended to indicate that the rare-earth oxide is limited to La₂O₃. Further, any number of additional components may assist within the adsorption of phosphate depending on the details of the specific implementation. For example, the particles may include La₂O₃ and any number of other rare-earth metal oxides, such as cerium oxide, yttrium oxide, gadolinium oxide, among others, that can be used to adsorb phosphate ions in environments with various ionic concentrations, pH concentration, diameters of particles, temperature, pressure, among others. Additionally, other mineral nanoparticles with adsorptive properties towards phosphate, such as aluminum-type phosphate binders, calcium-type phosphate binders and the like, may be used.

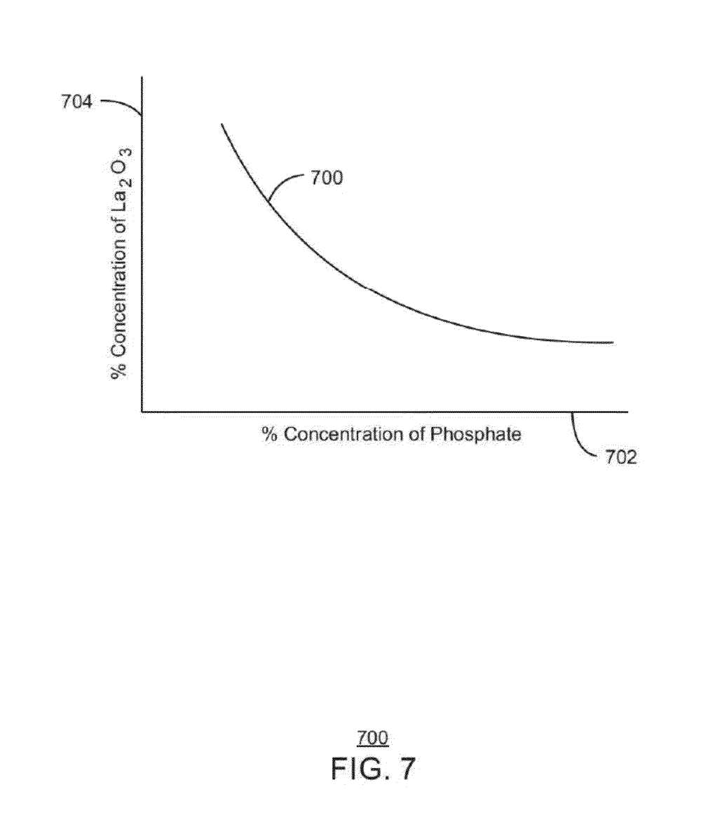

FIG. 7 is a theoretical plot 700 showing the variation of the percent concentration of phosphate 702 in a process flow in correlation to the percent concentration of La₂O₃ particles 704 that may be injected into the process flow. The percent concentration of phosphate 702 may range from about 0.01 ppm to about 10 ppm or from about .01 ppm to about 1 ppm. Many engineered hydrocarbon systems may have a phosphate concentration of about 0.1 to about 5 ppm, while certain systems may have phosphate concentrations below about 0.01 ppm or above about 10 ppm. The percent concentration of La₂O₃ particles 704 may range from about 1 ppm to about 1000 ppm or about 50 ppm to about 200 ppm. In some embodiments of the invention lanthanum oxide nanoparticles may be used at a concentration of below about 5 ppm. In other cases, a range of about 20 to about 200 ppm or about 50 ppm to about 200 ppm may be applied. There may be embodiments of the invention for which a dosage of more than about 200 and less than about 1000 ppm or more than about 500 ppm and less than about 1000 ppm of lanthanum oxide nanoparticles is desirable for effective microbial control. As shown from the plot 700, a higher percentage of La₂O₃ particles 704 can correlate to a lower percentage of phosphate concentration 702. Therefore, as the concentration of La₂O₃ increases, the concentration of phosphate decreases, thereby leading to a reduction or elimination of phosphate in the mixed phase system to control microbial activity and growth.

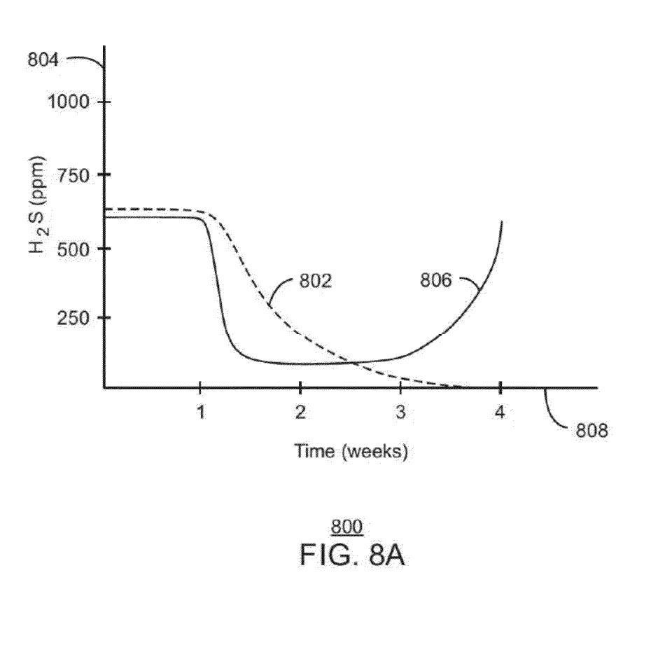

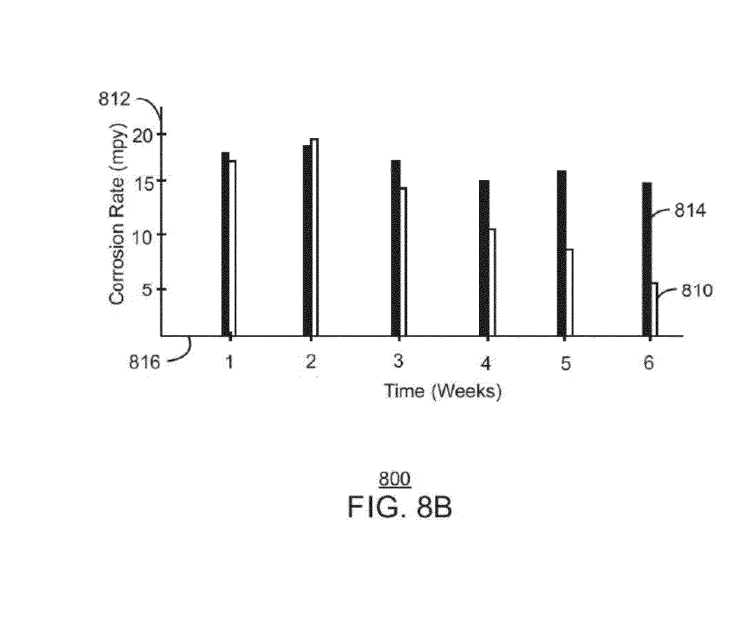

FIG. 8A is a plot showing a theoretical graph 800 of the influence of La₂O₃ particles 802 on biogenic H₂S concentration 804, as opposed to a biocide 806, in a laboratory bioreactor over a period of time 808. The flow-through bioreactor used to conduct the observations provides a simulation of reservoir souring in a well. In various laboratory experiments, commonly used biocides in the hydrocarbon industry are often ineffective at inhibiting reservoir souring and corrosion over time. This may be due in part to increasing microbial resistance against a particular biocide, ineffective concentrations of the biocide, the instability of the biocide in various processing environment, or a combination of such.

As shown in FIG. 8A, the biocide 806 proves ineffective at inhibiting the H₂S concentration 804 over a period of time 808. Over the same period of time, the La₂O₃ particles 802 effectively contribute to the continued reduction and eventual elimination of the H₂S concentration 804. Therefore, the shortcomings of the biocide are not expected to be exhibited by the La₂O₃ particles.

FIG. 8B is a plot showing a theoretical graph of the influence of La₂O₃ particles 810 on microbial corrosion rates 812, as opposed to an untreated system in which microbial corrosion is not mitigated 814, in a laboratory bioreactor over a period of time 816. The observations could be carried out by sampling corrosion coupons on a weekly basis and determining corrosion rates from a standard technique such as weight loss. The particles of La₂O₃ 810 are expected to reduce the microbial corrosion rate 812 as it also diminishes the number of metal-attached corrosive bacteria and decreases the corrosive H₂S concentration.

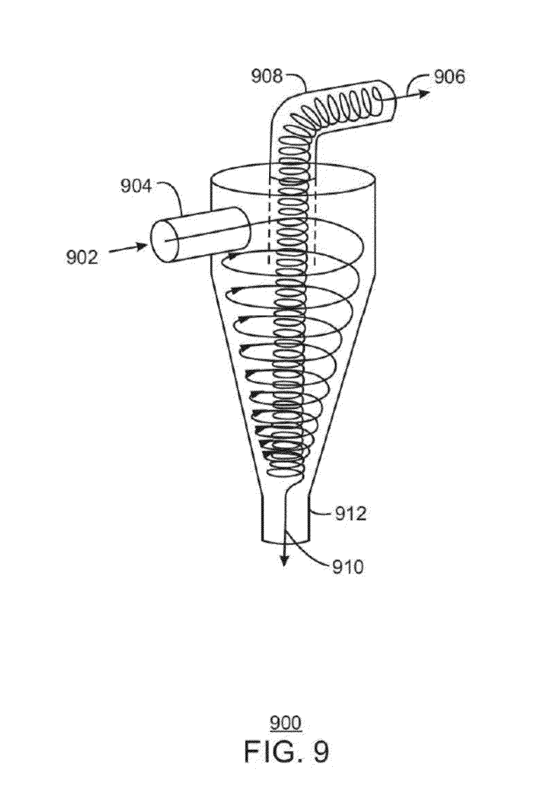

FIG. 9 is a drawing of a cyclone separator 900 that may be utilized to separate a mixed phase system consisting of an inorganic phase and an organic phase. FIG. 9 depicts the injection of the mixed phase system 902 through an inlet nozzle 904 to the cyclone separator 900. The cyclone separator 900 provides separation of the mixed phase system 902 into two separate flow streams including an organic flow stream and an inorganic flow stream. The organic flow stream can consist of a hydrocarbon mixture including oil and natural gas. The organic flow stream is indicated as overflow 906, which is conveyed overhead through the upper axial outlet 908. The inorganic flow stream can consist of produced water, rare-earth particles, and other entrained materials such as salts, chemicals, solids, and trace metals. The inorganic flow stream is shown as underflow 910, which is directed through the lower axial outlet 912. In certain embodiments, the hydrocarbons in the overflow 906 leaving the cyclone separator 900 through the upper axial outlet 908 may pass to a gravity separator which further separates the mixture into the constituents of oil and gas. Additionally, in other embodiments, unspent rare-earth oxide particles could be further separated from the underflow 910 and reintroduced by injection into a well.

Any number of additional components can be used with, or without, the cyclone separator 900 depending on the details of the specific implementation. For example, various embodiments may include any suitable types of mixers, propellers, blenders, nozzles, tanks, among others, to control the mixing and the flow of the suspension through the cyclone separator 900.

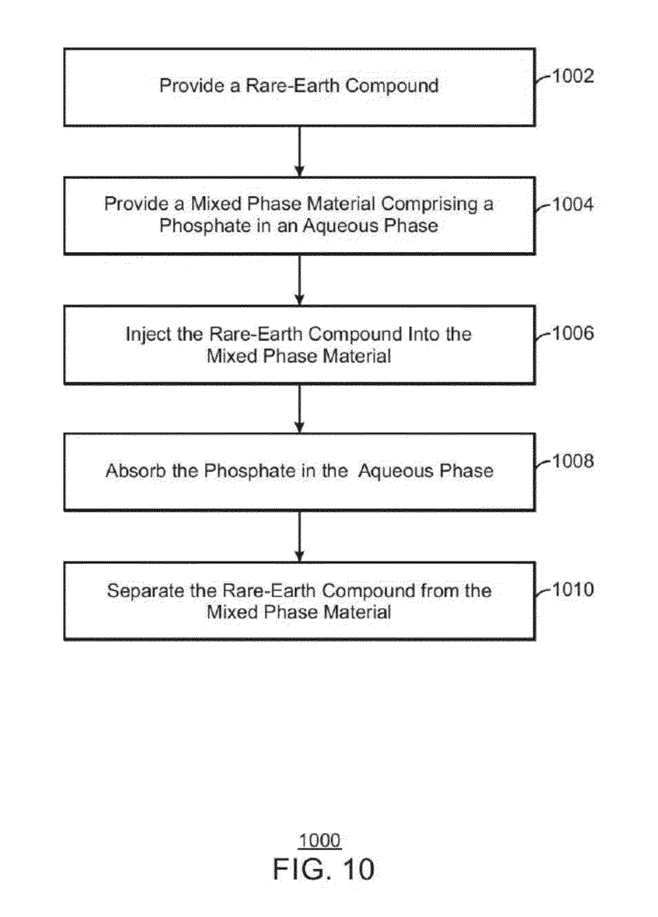

FIG. 10 is a process flow diagram of a method for injecting rare-earth oxide particles suspension into a mixed phase material. The method 1000 begins as block 1002 where a rare-earth compound is provided. At block 1004, a mixed phase system consisting of a phosphate in an aqueous phase is provided. At block 1006, the rare-earth compound is injected into the mixed phase system as described with respect to FIGS. 1-4A. At block 1008, the phosphate in the aqueous phase is readily adsorbed by the rare-earth compound as described with respect to FIGS. 3, 4A. At block 1010, the rare-earth compound is separated from the mixed phase system as described with respect to FIG. 9.

It should be understood that not all of the blocks of FIG. 10 may be used or needed in every embodiment. Depending on the service, such as additional materials added, mixing and separation techniques, specifications related to temperature, concentrations, pH levels and the like, different blocks may be added or removed.

### Embodiments

Embodiments of the invention may include any combinations of the methods and systems shown in the following numbered paragraphs. This is not to be considered a complete listing of all possible embodiments, as any number of variations can be envisioned from the description above.
1. A method for controlling microbial activity and growth in a mixed phase system, including:
providing a rare-earth compound;
injecting the rare-earth compound into a mixed phase system, wherein the rare earth compound binds with a phosphate in an aqueous phase to adsorb the phosphate; and separating the rare-earth compound from the mixed phase system.
2. The method of paragraph 1, further including providing the mixed phase system with an organic phase and an inorganic phase.
3. The method of paragraph 2, further including mixing the rare-earth compound with an aqueous solution to form a suspension before injection into the mixed phase system.
4. The method of paragraph 3, further including mixing the suspension in a mixing tank before injection into the mixed phase system.
5. The method of paragraph 3, further including injecting the suspension into the mixed phase system using a feeding system.
6. The method of paragraph 5, further including supplying pressure from a pump to blend the suspension with the mixed phase system.
7. The method of paragraph 4, further including allowing the suspension in the mixing tank to flow through an injection line and into a tubular construct containing the mixed phase material.
8. The method of any of the preceding paragraphs, wherein the rare-earth compound binds directly to the phosphate in the aqueous phase.
9. The method of any of the preceding paragraphs, wherein the aqueous phase is substantially removed of phosphate.
10. The method of paragraph 2, further including passing the organic phase and the inorganic phase into a cyclone separator to produce an overflow that is substantially included of the organic phase and an underflow that is substantially included of the inorganic phase.
11. The method of paragraph 10, further including passing the suspension into the cyclone separator through the underflow.
12. The method of paragraph 11, further including recycling the rare-earth compound in the suspension for reuse after passing the suspension into the cyclone separator.
13. A method for controlling microbial activity and growth during hydrocarbon production, the method including:
completing a well in a formation to access a reservoir, wherein the reservoir includes a mixed phase material including a phosphate in an aqueous phase;
injecting a rare-earth compound into the well, wherein the rare-earth compound flows into the mixed phase material and binds with the phosphate in the aqueous phase;
removing the mixed phase material from the well;
separating a hydrocarbon-containing material from the mixed phase material; and
separating the rare-earth compound from the hydrocarbon-containing material.
14. The method of paragraph 13, wherein the rare-earth compound is in particle form having a porous structure.
15. The method of either of paragraphs 13 or 14, wherein the rare-earth compound is included of lanthanum oxide particles.
16. The method of paragraph 15, wherein the concentration of the lanthanum oxide particles is in the range of about 1 ppm to about 1000 ppm.
17. The method of paragraph 15, wherein the concentration of the lanthanum oxide particles is in the range of about 50 ppm to about 200 ppm.
18. The method of any of paragraphs 13-17, wherein the rare-earth compound is included of cerium oxide, yttrium oxide, or gadolinium oxide.
19. The method of any of paragraphs 13-18, wherein any compound that adsorbs phosphate is injected into the reservoir.
20. A system for inhibiting bacteria growth, the system including:
a mixed phase system including phosphate in an aqueous phase
a rare-earth compound in an aqueous mixture to form a rare-earth suspension;
an injection system to inject the rare-earth suspension into the mixed phase system to adsorb the phosphate in the aqueous phase; and
a separation system to separate the rare-earth suspension from the mixed phase system.
21. The system of paragraph 20, wherein the mixed phase system includes an organic and an inorganic phase.
22. The system of paragraph 21, wherein the organic phase includes hydrocarbons.
23. The system of paragraph 22, where the hydrocarbons include oil or gas or both.
24. The system of paragraph 21, wherein the inorganic phase includes an aqueous solution.
25. The system of any of paragraphs 20-24, wherein the mixed phase system is contained within a tubular construct.
26. The system of any of paragraphs 20-25, wherein the rare-earth compound includes a lanthanum oxide (La₂O₃) concentration ranging from about 1 ppm to about 1000 pm.
27. The system of any of paragraphs 20-26, wherein the mixed phase system includes a phosphate concentration ranging from about 0.01 ppm to about 10 ppm.
28. The system of any of paragraphs 20-27, wherein the rare-earth suspension is mixed in a mixing tank prior to injection into the mixed phase system.
29. The system of paragraph 28, wherein the rare-earth suspension is pumped from the mixing tank through an injection line and into the mixed phase system.
30. The system of any of paragraphs 20-29, wherein the rare-earth suspension is injected into a flow stream of the mixed phase system in a reservoir extraction process.
31. The system of any of paragraphs 20-30, wherein the rare-earth suspension is injected into the flow stream of the mixed phase system in a hydraulic fracturing process.
32. The system of any of paragraphs 20-31, wherein the mixed phase system is substantially free of phosphate after adsorption.
33. The system of any of paragraphs 20-32, wherein a residual amount of phosphate is in the range of about 0.0001 ppm to about 0.01 ppm after adsorption.
34. The system of any of paragraphs 20-33, including a measurement system to measure the concentration of phosphate remaining after adsorption.

While the present techniques may be susceptible to various modifications and alternative forms, the embodiments discussed above have been shown only by way of example. However, it should again be understood that the techniques is not intended to be limited to the particular embodiments disclosed herein. Indeed, the present techniques include all alternatives, modifications, and equivalents falling within the true spirit and scope of the appended claims.

1. A method for controlling microbial activity and growth in a mixed phase system, comprising:
providing a rare-earth compound;
injecting the rare-earth compound into a mixed phase system, wherein the rare earth compound binds with a phosphate in an aqueous phase to adsorb the phosphate; and
separating the rare-earth compound from the mixed phase system.

2. The method of claim 1, further comprising providing the mixed phase system with an organic phase and an inorganic phase.

3. The method of claim 2, further comprising mixing the rare-earth compound with an aqueous solution to form a suspension before injection into the mixed phase system.

4. The method of claim 3, further comprising mixing the suspension in a mixing tank before injection into the mixed phase system.

5. The method of claim 3, further comprising injecting the suspension into the mixed phase system using a feeding system.

6. The method of claim 5, further comprising supplying pressure from a pump to blend the suspension with the mixed phase system.

7. The method of claim 4, further comprising allowing the suspension in the mixing tank to flow through an injection line and into a tubular construct containing the mixed phase material.

8. The method of claim 1, wherein the rare-earth compound binds directly to the phosphate in the aqueous phase.

9. The method of claim 1, wherein the aqueous phase is substantially removed of phosphate.

10. The method of claim 2, further comprising passing the organic phase and the inorganic phase into a cyclone separator to produce an overflow that is substantially comprised of the organic phase and an underflow that is substantially comprised of the inorganic phase.

11. The method of claim 10, further comprising passing the suspension into the cyclone separator through the underflow.

12. The method of claim 11, further comprising recycling the rare-earth compound in the suspension for reuse after passing the suspension into the cyclone separator.

13. A method for controlling microbial activity and growth during hydrocarbon production, the method comprising:
completing a well in a formation to access a reservoir, wherein the reservoir comprises a mixed phase material comprising a phosphate in an aqueous phase;
injecting a rare-earth compound into the well, wherein the rare-earth compound flows into the mixed phase material and binds with the phosphate in the aqueous phase;
removing the mixed phase material from the well;
separating a hydrocarbon-containing material from the mixed phase material; and
separating the rare-earth compound from the hydrocarbon-containing material.

14. The method of claim 13, wherein the rare-earth compound is in particle form having a porous structure.

15. The method of claim 13, wherein the rare-earth compound is comprised of lanthanum oxide particles.

16. The method of claim 15, wherein the concentration of the lanthanum oxide particles is in the range of about 1 ppm to about 1000 ppm.

17. The method of claim 15, wherein the concentration of the lanthanum oxide particles is in the range of about 50 ppm to about 200 ppm.

18. The method of claim 13, wherein the rare-earth compound is comprised of cerium oxide, yttrium oxide, or gadolinium oxide.

19. The method of claim 13, wherein any compound that adsorbs phosphate is injected into the reservoir.

20. A system for inhibiting bacteria growth, the system including:
a mixed phase system comprising phosphate in an aqueous phase;
a rare-earth compound in an aqueous mixture to form a rare-earth suspension;
an injection system to inject the rare-earth suspension into the mixed phase system to adsorb the phosphate in the aqueous phase; and
a separation system to separate the rare-earth suspension from the mixed phase system.

21. The system of claim 20, wherein the mixed phase system includes an organic and an inorganic phase.

22. The system of claim 21, wherein the organic phase includes hydrocarbons.

23. The system of claim 22, where the hydrocarbons include oil or gas or both.

24. The system of claim 21, wherein the inorganic phase includes an aqueous solution.

25. The system of claim 20, wherein the mixed phase system is contained within a tubular construct.

26. The system of claim 20, wherein the rare-earth compound includes a lanthanum oxide (La₂O₃) concentration ranging from about 1 ppm to about 1000 pm.

27. The system of claim 20, wherein the mixed phase system includes a phosphate concentration ranging from about 0.01 ppm to about 10 ppm.

28. The system of claim 20, wherein the rare-earth suspension is mixed in a mixing tank prior to injection into the mixed phase system.

29. The system of claim 28, wherein the rare-earth suspension is pumped from the mixing tank through an injection line and into the mixed phase system.

30. The system of claim 20, wherein the rare-earth suspension is injected into a flow stream of the mixed phase system in a reservoir extraction process.

31. The system of claim 20, wherein the rare-earth suspension is injected into the flow stream of the mixed phase system in a hydraulic fracturing process.

32. The system of claim 20, wherein the mixed phase system is substantially free of phosphate after adsorption.

33. The system of claim 20, wherein a residual amount of phosphate is in the range of about 0.0001 ppm to about 0.01 ppm after adsorption.

34. The system of claim 20, including a measurement system to measure the concentration of phosphate remaining after adsorption.
